(19) United States
(12) Patent Application Publication
(10) Pub. No.: US 2003/0123366 A1
(43) Pub. Date: Jul. 3, 2003

(54) Optical disc loading tray

(76) Inventor: Hung-Chieh Cheng, Taipei Hsien (TW)

Correspondence Address: BIRCH STEWART KOLASCH & BIRCH, PO BOX 747, FALLS CHURCH, VA, 22040-0747, US

(21) Appl. No.: 10/028,774

(22) Filed: Dec. 28, 2001

(51) Int. Cl. G11B 33/02

(52) U.S. Cl. 369/75.2; 369/77.2

(57) ABSTRACT

An optical disc loading tray used in conjunction with an optical disc player. The optical disc loading tray has a plate shape with a flat surface on which an open type optical disc loading area is formed. An optical pickup head opening is formed in the optical disc loading area. At least a fixing hole and a positioning hole are formed in the optical disc loading tray. The fixing hole and the positioning slot cooperate with the positioning mechanism of the optical disc player. Thus, the optical pickup head of the optical disc player can perform data reading/writing processes when the optical disc loading tray with the optical disc is transported to the reading/writing position in the optical disc player.

### BACKGROUND OF THE INVENTION

1. Field of the Invention

The invention relates to an optical disc loading tray, in particular to an optical disc loading tray for a bare optical disc, such as a bare DVD-RAM.

2. Description of the Related Art

In order to meet the requirements for information storage in the multimedia age, the technological development in optical discs has advanced greatly. From the early optical discs such as CDs, MOs, and DVD-ROMs to the current optical discs such as DVD-RAMs (Digital Versatile Disc Random Access Memory), not only has the storage capacity increased, but there has also been advanced in technology. In a DVD-RAM, the phase change material is used as the recording layer so that the disc is rewrittable. The main specifications for the storage capacity of the DVD-RAMs include 2.6 GB and 4.7 GB.

As shown in FIG. 1, in order to prevent the data recorded on the DVD-RAM from being damaged and lost when the disc is contaminated or scraped, an optical disc 8 is placed in a disc cartridge 1. The disc cartridge 1 includes a cartridge body 11 and a shutter 9. The cartridge body 11 has an optical pickup opening 111. The shutter 9 is arranged on the cartridge body 11 and is driven by a shutter-open mechanism (not shown) in an optical disc player 2 so as to shut or expose the optical pickup opening 111.

In general, the optical disc player 2 is divided into a disc player with a tray or a disc player without a tray. The optical disc player 2 shown in FIG. 1 is one with a tray 21. When a signal to eject is received by the optical disc player 2, the tray 21 is moved to the outside of the optical disc player 2, as shown in FIG. 1. As shown in FIG. 2, when the disc cartridge 1 is loaded into the optical disc player 2, the disc cartridge 1 is fixed by an engaging slot 116 and a fixing mechanism 211 within the tray 21. When the user inputs a load signal, a driving motor in the optical disc player is activated to transport the tray 21 and the disc cartridge 1 loaded therein into the optical disc player 2. In this case, a rising mechanism corresponding to a fixing hole 113 of the disc cartridge 1 in the optical disc player 2 rises to hold the disc cartridge 1. In addition, a positioning slot 114 is formed in the disc cartridge 1, and the optical disc player 2 has a positioning mechanism corresponding to the positioning slot 114. The positioning slot 114 and the positioning mechanism in the optical disc player prevent the user from incorrectly placing the disc cartridge 1. More importantly, the disc cartridge 1 can be positioned at a predetermined location in the optical disc player 2. A write-inhibit hole 115 is provided with a write-inhibit switch (not shown). A write-inhibit sensor is provided at a location corresponding to the write-inhibit hole 115 in the optical disc player 2 for detecting whether the optical disc 8 is in the write-inhibit mode or not.

When the positioning of the disc cartridge 1 is finished, the shutter 9 is opened by the shutter-open mechanism of the optical disc player 2 so that the optical pickup opening 111 is exposed. Therefore, the optical disc 8 loaded within the disc cartridge 1 can be read/written by the optical pickup head in the optical disc player 2.

Since most current DVD-RAM optical disc players can only operate in conjunction with a disc cartridge, if a general bare DVD-RAM is directly loaded into the DVD-RAM optical disc player the optical disc will not be recognized as a playable disc by the DVD-RAM optical disc player. Therefore, the data recorded in the optical disc cannot be read and the optical disc also cannot be written to. In addition, compared to the bare DVD-RAMs, the cost of the protected DVD-RAMs is increased due to the added protection case thus the selling price of the DVD-RAMs is also increased. However, for general consumers, the protection case is not necessary because he or she can store the optical discs in a special optical disc storage box to prevent the optical discs from being contaminated or scraped. In other words, the intention for each consumer to buy a DVD-RAM with a protection case is lowered due to the increased cost of the optical disc.

It is therefore an important subject matter to greatly decrease the cost of the DVD-RAM, so as to attract the consumers to buy the optical discs.

### SUMMARY OF THE INVENTION

In view of the above-mentioned problems, it is therefore an object of the invention to provide an optical disc loading tray in which a bare optical disc such as a DVD-RAM can be loaded, so that the optical pickup head of the optical disc player can read/write data normally. Thus, the additional protection case of the DVD-RAM can be omitted, thereby greatly decreasing the materials and manufacturing cost.

To achieve the above-mentioned object, the invention provides an optical disc loading tray used in conduction with an optical disc player. The optical disc loading tray has a plate shape with a flat surface on which an open type optical disc loading area is formed. An optical pickup head opening is formed in the optical disc loading area. At least a fixing hole and a positioning hole are formed at a front portion of the optical disc loading tray relative to a direction along which the optical disc loading tray is loaded into the optical disc player. The fixing hole and the positioning slot cooperate with the corresponding mechanism of the optical disc player.

Therefore, by using the optical disc loading tray of the invention, since the fixing hole and the positioning slot cooperate with the corresponding mechanism of the optical disc player, the existence of a bare optical disc such as a DVD-RAM can be identified so that the data reading/writing processes can be performed on the optical disc. Thus, the problem of the optical disc player cannot identifying the existence of a bare optical disc can be solved. In addition, a shutter, a spring worked in conjunction with the shutter, a protection case for receiving an optical disc in the conventional disc cartridge, and the like can be omitted in the optical disc loading tray of the invention, thereby greatly lowering the costs of DVD-RAMs.

### BRIEF DESCRIPTION OF THE DRAWINGS

FIG. 1 is a pictorial view showing a conventional disc cartridge and an optical disc player that is operated in conjunction with the disc cartridge.

FIG. 2 is a top view showing the state that the conventional disc cartridge is loaded in the tray of the optical disc player.

FIG. 3 is a top view showing an optical disc loading tray in accordance with a preferred embodiment of the invention.

FIG. 4 is a pictorial view showing the optical disc loading tray in accordance with the preferred embodiment of the invention.

FIG. 5 is a pictorial view showing the optical disc loading tray in accordance with the preferred embodiment of the invention and an optical disc player that is operated in conjunction with the disc loading tray.

FIG. 6 is a top view showing the state that the optical disc loading tray in accordance with the preferred embodiment of the invention is loaded in the tray of the optical disc player.

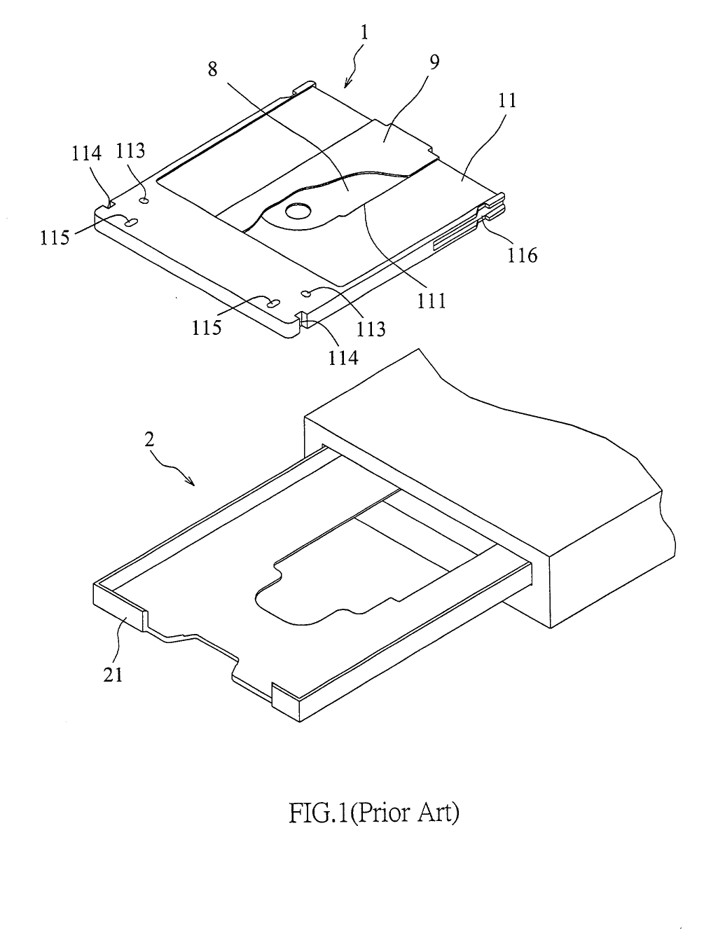

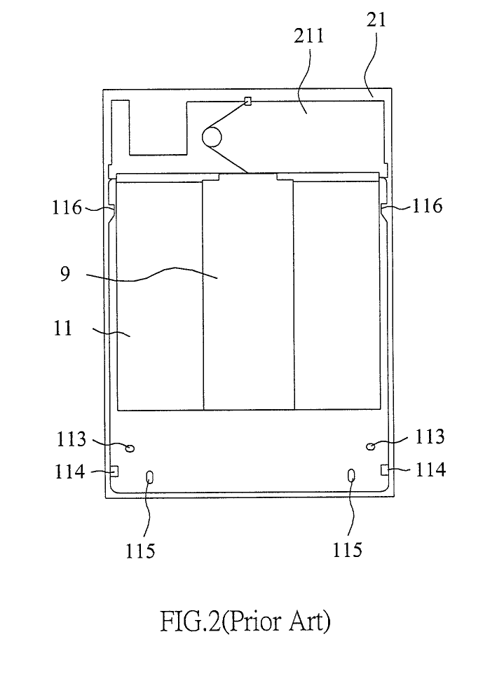

### DETAILED DESCRIPTION OF THE PREFERRED EMBODIMENT

The optical disc loading tray in accordance with a preferred embodiment of the invention will be described with reference to the accompanying drawings.

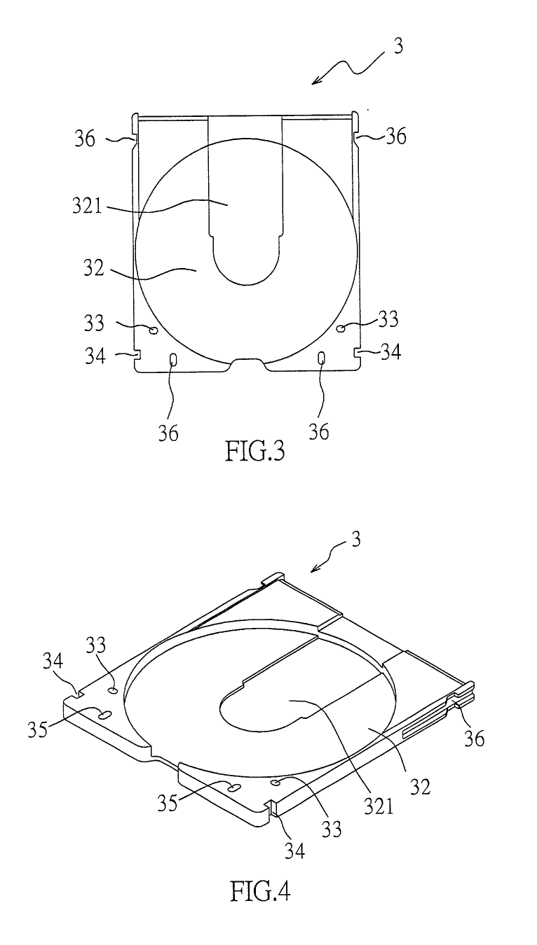

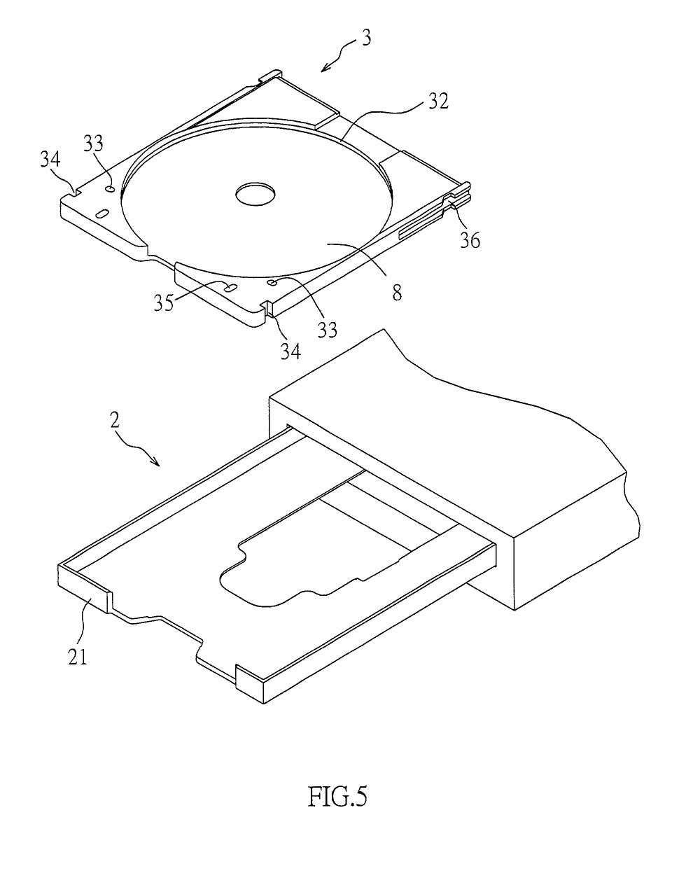

FIG. 3 is a top view showing an optical disc loading tray 3 in accordance with a preferred embodiment of the invention. FIG. 4 is a pictorial view showing the optical disc loading tray 3. The optical disc loading tray 3 as shown in FIGS. 3 and 4 is used in conjunction with an optical disc player. The optical disc loading tray 3 has a plate shape and has one flat surface as an optical disc loading surface.

In this embodiment, an optical disc loading area 32 with an open type configuration is formed on the optical disc loading surface. The open type configuration means that the optical disc loading tray 3 has no protection cover as that in the conventional disc cartridge. Furthermore, the size of the optical disc loading area 32 can be matched with that of the optical disc so that the optical disc can be directly placed in the optical disc loading area 32. In addition, an optical pickup head opening 321 having a specification consistent with that of the prior art is formed in the optical disc loading area 32. Thus, the optical disc can be read/written by a common optical disc player.

As shown in FIG. 5, when an optical disc player 2 receives a signal to eject, a tray 21 moves to the outside of the optical disc player 2. Thus, the optical disc loading tray 3 with an optical disc 8 can be loaded into the optical disc player 2.

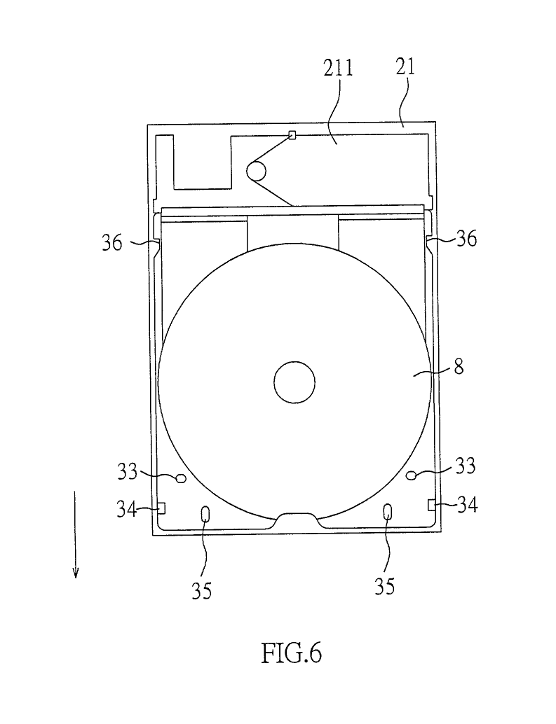

As shown in FIG. 6, when the user inputs a loading signal to activate a driving motor, the optical disc loading tray 3 with the optical disc 8 is transported to the optical disc player 2. At this time, engaging slots 36 and a fixing mechanism 211 in the tray 21 fix the optical disc loading tray 3, wherein the engaging slots 36 are formed on side surfaces of a rear portion of the optical disc loading tray. It should be noted that “rear” represents a direction opposite to the direction along which the optical disc loading tray 3 is loaded into the optical disc player 2, that is, the opposite direction to the direction indicated by the arrow in FIG. 6.

In this embodiment, fixing holes 33 penetrating through the flat surface of the optical disc loading tray 3 are formed at the front portion of the optical disc loading tray 3. In this embodiment, “front” refers to a direction along which the optical disc loading tray 3 is loaded into the optical disc player 2, as indicated by the arrow in FIG. 6. When the optical disc loading tray 3 with the optical disc 8 is loaded into the optical disc player 2, an rising mechanism (not shown) corresponding to the two fixing holes 33 in the optical disc player 2 is risen to hold the optical disc loading tray 3.

In addition, in this embodiment, positioning slots 34 are formed on the side surfaces of the front portion of the optical disc loading tray 3, wherein “front” represents the direction indicated by the arrow in FIG. 6. When the optical disc loading tray 3 with the optical disc 8 is loaded into the optical disc player 2, the optical disc loading tray 3 is positioned by a positioning mechanism provided at a predetermined location corresponding to the positioning slots 34 in the optical disc player 2. The positioning mechanism prevents the user from incorrectly placing the optical disc loading tray 3.

Moreover, write-inhibit holes 35 are formed on the front portion of the optical disc loading tray 3. A write-inhibit switch (not shown) is provided in each write-inhibit hole. A write-inhibit sensor is provided at a location corresponding to each write-inhibit hole 35 in the optical disc player 2, for detecting whether the optical disc 8 is under the protection of write-inhibit or not.

In the prior art, after the optical disc loading tray 3 with the optical disc 8 is positioned, the shutter is opened by the shutter-open mechanism of the optical disc player 2 to expose the optical disc. In this embodiment, however, the operation of the optical pickup head of the optical disc player is not influenced even if no shutter is provided on the optical disc loading tray 3.

To sum up, the structure of the optical disc loading tray of the invention is designed according to the original fixing mechanism and judging mechanism in the optical disc player. Thus, by using the optical disc loading tray, the existence of the bare DVD-RAM can be detected by the DVD-RAM optical disc player so that further data reading/writing processes can be performed. Therefore, the costs for the protection case, the shutter, and other mechanisms can be saved without modifying the original mechanism of the optical disc player. In other words, the optical disc loading tray of the invention with the bare optical disc loaded in can be used in the DVD-RAM optical disc player. Thus, the costs of the DVD-RAMs can be greatly lowered so as to attract the consumer to buy the DVD-RAMs.

While the invention has been described by way of an example and in terms of a preferred embodiment, it is to be understood that the invention is not limited to the disclosed embodiment. To the contrary, it is intended to cover various modifications. For instance, the optical disc loading tray of the invention may be mounted onto the tray of the optical disc player so that the bare DVD-RAMs can be advantageously placed therein. In addition, the optical disc loading tray can also be applied to other storage media with a protection cartridge in the same manner. Therefore, the scope of the appended claims should be accorded the broadest interpretation so as to encompass all such modifications.

What is claimed is:

1. An optical disc loading tray used in conjunction with an optical disc player, the optical disc loading tray having a plate shape with a flat surface, the optical disc loading tray comprising an open type optical disc loading area formed on the flat surface, an optical pickup head opening formed in the optical disc loading area, and at least a fixing hole and a positioning hole formed at a front portion of the optical disc loading tray relative to a direction along which the optical disc loading tray is loaded into the optical disc player.

2. The optical disc loading tray according to claim 1, wherein the fixing hole penetrates through the flat surface of the optical disc loading tray.

3. The optical disc loading tray according to claim 1, wherein the positioning slot is formed on a side surface of the front portion of the optical disc loading tray.

4. The optical disc loading tray according to claim 1, wherein at least a write-inhibit hole is formed at the front portion of the optical disc loading tray.

5. The optical disc loading tray according to claim 4, wherein a write-inhibit switch is provided in the write-inhibit hole.

6. The optical disc loading tray according to claim 1, wherein at least an engaging slot is formed in the optical disc loading tray.

7. The optical disc loading tray according to claim 6, wherein the engaging slot is formed on a side surface of a rear portion of the optical disc loading tray.

8. An optical disc player used in conjunction with an optical disc loading tray, the optical disc loading tray having a plate shape with a flat surface, the optical disc loading tray including an open type optical disc loading area formed on the flat surface, an optical pickup head opening formed in the optical disc loading area, and at least a fixing hole and a positioning hole formed at a front portion of the optical disc loading tray relative to a direction along which the optical disc loading tray is loaded into the optical disc player, the optical disc player comprising:
an optical pickup head positioned corresponding to the optical pickup head opening for reading/writing the optical disc loaded in the optical disc loading area;
a rising mechanism positioned corresponding to the fixing hole so as to hold the optical disc loading tray in the optical disc player in conjunction with the fixing hole; and
a positioning mechanism positioned corresponding to the positioning slot so as to prevent the optical disc loading tray from being incorrectly placed into the optical disc player.

9. An optical disc loading tray for an optical disc to be loaded in and for being used in conjunction with an optical disc player, the optical disc player including an optical pickup head, a rising mechanism, and a positioning mechanism, the optical disc loading tray being formed with:
an open type optical disc loading area formed on a flat surface of the optical disc loading tray for supporting the optical disc;
an optical pickup head opening formed in the optical disc loading area and positioned corresponding to the optical pickup head of the optical disc player;
a fixing hole formed on the flat surface and penetrating through the optical disc loading tray, the fixing hole being positioned corresponding to the rising mechanism of the optical disc player; and
a positioning slot formed on a side surface perpendicular to the flat surface and positioned corresponding to the positioning mechanism of the optical disc player.

10. The optical disc loading tray according to claim 9, wherein the optical disc loading tray is integrally formed.

11. The optical disc loading tray according to claim 9, wherein a write-inhibit hole is formed at a front portion of the optical disc loading tray relative to a direction along which the optical disc loading tray is loaded into the optical disc player.

12. The optical disc loading tray according to claim 11, wherein a write-inhibit switch is provided in the write-inhibit hole.

13. The optical disc loading tray according to claim 9, wherein an engaging slot is formed at a rear portion of the optical disc loading tray relative to a direction along which the optical disc loading tray is loaded into the optical disc player.
